(19) United States
(12) Patent Application Publication
(10) Pub. No.: US 2024/0172032 A1
(43) Pub. Date: May 23, 2024

(54) METHOD APPLIED TO COMMUNICATION SYSTEM AND COMMUNICATION APPARATUS

(71) Applicant: GUANGDONG OPPO MOBILE TELECOMMUNICATIONS CORP., LTD., Dongguan (CN)

(72) Inventors: Jingran CHEN, Dongguan (CN); Yang XU, Dongguan (CN)

(21) Appl. No.: 18/405,827

(22) Filed: Jan. 5, 2024

Related U.S. Application Data
(63) Continuation of application No. PCT/CN2021/105065, filed on Jul. 7, 2021.

(51) Int. Cl. H04W 28/02; H04W 28/08; H04W 76/20

(52) U.S. Cl. CPC H04W 28/0252; H04W 28/0967; H04W 76/20

(57) ABSTRACT

Provided is a method applicable to a communication system. The communication system supports establishments of a user plane-based first connection, a control plane-based second connection, and a third connection for transmitting an AI data stream for a network element in the communication system, wherein a plurality of network elements of the communication system are involved on a transmission path of the AI data stream, and the third connection is established between the plurality of network elements. The plurality of network elements include a first network element and a second network element. The method includes: sending to or receiving from the second network element, by the first network element, the AI data stream over the third connection.

### CROSS-REFERENCE TO RELATED APPLICATION

This application is a continuation application of international application No. PCT/CN2021/105065, filed on Jul. 7, 2021, the entire contents of which are incorporated herein by reference.

### TECHNICAL FIELD

The present disclosure relates to the technical field of communications, and in particular, relates to a method applicable to a communication system and a communication apparatus.

### BACKGROUND

With the development of the artificial intelligence (AI) technology, for some wireless network-based communication systems, it is desirable to empower AI to various network elements in the communication systems to further improve the performance of the communication systems.

### SUMMARY

The present disclosure provides a method applicable to a communication system and a communication apparatus to support AI-related processing on the communication system.

According to some embodiments of the present disclosure, a method applicable to a communication system is provided. The communication system supports establishments of a user plane-based first connection, a control plane-based second connection, and a third connection for transmitting an artificial intelligence (AI) data stream for a network element in the communication system, wherein a plurality of network elements of the communication system are involved on a transmission path of the AI data stream, and the third connection is established between the plurality of network elements. The plurality of network elements includes a first network element and a second network element. The method includes: sending to or receiving from the second network element, by the first network element, the AI data stream over the third connection.

According to some embodiments of the present disclosure, a communication apparatus is provided. The communication apparatus is disposed in a communication system. The communication system supports establishments of a user plane-based first connection, a control plane-based second connection, and a third connection for transmitting an artificial intelligence (AI) data stream for a network element in the communication system, wherein a plurality of network elements of the communication system are involved on a transmission path of the AI data stream, and the third connection is established between the plurality of network elements. The plurality of network elements includes a first network element and a second network element. The communication apparatus is the first network element. The communication apparatus includes a communication unit configured to send to or receive from the second network element the AI data stream over the third connection.

According to some embodiments of the present disclosure, a communication apparatus is provided. The communication apparatus includes a memory and a processor, wherein the memory is configured to store a program, and the processor is configured to call the program from the memory to perform the method as described in the above embodiments.

According to some embodiments of the present disclosure, an apparatus is provided. The apparatus includes a processor configured to call a program from a memory to perform the method as described in the above embodiments.

According to some embodiments of the present disclosure, a chip is provided. The chip includes a processor configured to call a program from a memory to cause a device provided with the chip to perform the method as described in the above embodiments.

According to some embodiments of the present disclosure, a computer-readable storage medium is provided. The computer-readable storage medium is configured to store a program, wherein the program causes a computer to perform the method as described in the above embodiments.

According to some embodiments of the present disclosure, a computer program product is provided. The computer program product includes a program, wherein the program causes a computer to perform the method as described in the above embodiments.

According to some embodiments of the present disclosure, a computer program is provided, wherein the computer program causes a computer to perform the method as described in the above embodiments.

### BRIEF DESCRIPTION OF DRAWINGS

FIG. 1 is an example diagram of a basic structure of a neural network;

FIG. 2 is an example diagram of a basic structure of a convolutional neural network;

FIG. 3 is an example diagram of a system architecture which is applicable to a communication system of some embodiments of the present disclosure;

FIG. 4 is a schematic diagram of 5G system architecture;

FIG. 5 is an example diagram of a scenario in which the communication system is combined with a segmentation model according to some embodiments of the present disclosure;

FIG. 6 is an example diagram of a scenario in which the communication system is combined with big data analysis according to some embodiments of the present disclosure;

FIG. 7 is a schematic flowchart of a method applicable to the communication system according to some embodiments of the present disclosure;

FIG. 8 is a structural schematic diagram of a header of a data packet in an AI data stream according to some embodiments of the present disclosure;

FIG. 9 is an example diagram of a structure of a protocol stack capable of supporting an AI connection according to some embodiments of the present disclosure;

FIG. 10 is a structural schematic diagram of a communication apparatus according to some embodiments of the present disclosure; and

FIG. 11 is a structural schematic diagram of an online trained apparatus according to some embodiments of the present disclosure.

### DETAILED DESCRIPTION

For ease of understanding, some concepts and application scenarios involved in embodiments of the present disclosure are firstly introduced.

AI Technology

In recent years, research on AI technology has achieved great results in many fields, and AI technology will also play an important role in people's production and life for a long time to come.

The AI technology may simulate human logical analysis and inference processes based on an AI model. Therefore, the selection, training and use of the AI model are hot issues in the AI technology. The AI model is illustrated in more detail hereinafter by taking a neural network as an example. However, it should be noted that the AI model mentioned in the embodiments of the present disclosure is not limited to the neural network, and may also be any other type of machine learning model in addition to the neural network.

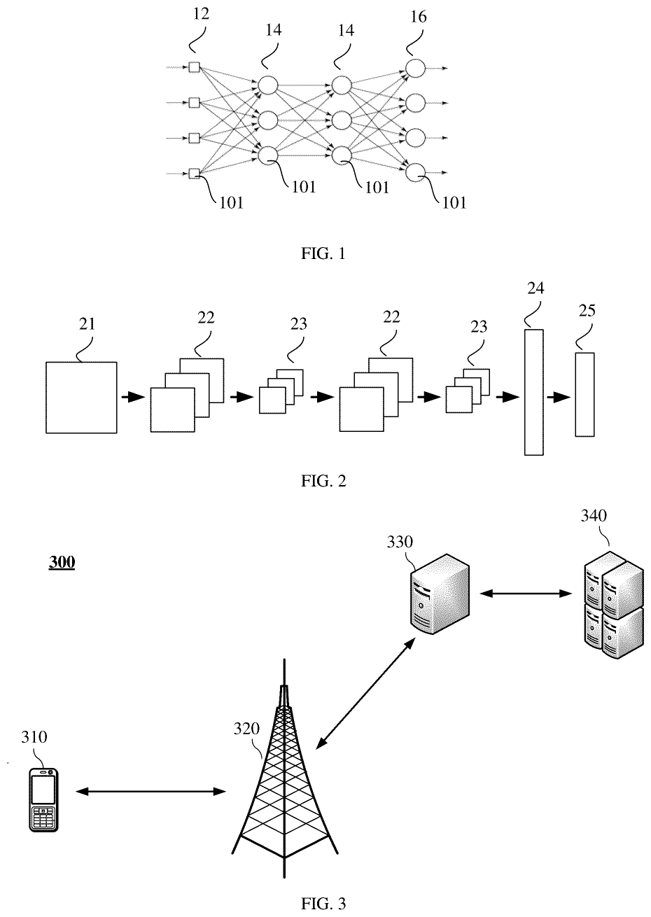

FIG. 1 is an example diagram of a basic structure of a neural network. FIG. 1 shows a basis structure of a simple neutral network. As shown in FIG. 1, the neural network includes an input layer 12, one or more hidden layers 14, and an output layer 16. Data is input to the input layer 12 and processed by the hidden layers 14, and a final result is generated by the output layer 16.

The neural network includes a plurality of nodes 101, and each node 101 represents a processing unit. Each node 101 in the neural network simulates a neuron. A plurality of neurons 101 constitute a neural network layer. The transmission and processing of information between a plurality of neural network layers constructs a complete neural network.

With continuous the development of the neural network technology, the concept of a deep neural network has been proposed in recent years. Compared with the simple neural network shown in FIG. 1, the deep neural network introduces more hidden layers. By introducing a plurality of hidden layers, the learning and processing capabilities of the neural network are greatly improved, such that the neural network are widely used in pattern recognition, signal processing, combinatorial optimization, anomaly detection, or the like.

With the development of the deep neural network technology, a convolutional neural network was proposed. FIG. 2 is an example diagram of a basic structure of a convolutional neural network. As shown in FIG. 2, one convolutional neural network includes an input layer 21, a plurality of convolutional layers 22, a plurality of pooling layers 23, a fully connected layer 24, and an output layer 25. The introduction of the convolutional layers 22 and the pooling layers 23 limits the number of model parameters, such that a sharp increase in model parameters of the neural network is effectively controlled, thereby improving the robustness of an algorithm.

Communication System

A communication system mentioned in the embodiments of the present disclosure refers to a communication system based on a wireless communication network. FIG. 3 is an example diagram of a system architecture which is applicable to a communication system of some embodiments of the present disclosure. As shown in FIG. 3, the communication system 300 includes a user equipment (UE) 310, an access network device 320, and a core network device 330.

The UE 310 may also be referred to as a terminal device, an access terminal, a user unit, a user station, a mobile station (MS), a mobile terminal (MT), a remote station, a remote terminal, a mobile device, a user terminal, a terminal, a wireless communication device, a user agent, or a user apparatus. The UE 310 in the embodiments of the present disclosure is a device that provides voice and/or data connectivity to users, and is configured to connect persons, things, and machines, such as a handheld device, a vehicle-mounted device or the like having a wireless connection function. The UE 310 in the embodiments of the present disclosure is a mobile phone, a tablet computer (Pad), a notebook computer, a handheld computer, a mobile internet device (MID), a wearable device, a virtual reality (VR) device, an augmented reality (AR) device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, or the like. In some embodiments, the UE 310 is used as a base station. For example, the UE 310 serves as a scheduling entity that provides a sidelink signal between UEs in V2X or D2D or the like. For example, a cellular phone and an automobile communicate with each other with sidelink signals. A cellular phone and a smart home device communicate with each other without relaying communication signals by a base station.

The access network device 320 is a device configured to communicate with the UE 310. The access network device 320 may also be referred to as a base station sometimes. The access network device 320 in the embodiments of the present disclosure may refer to a radio access network (RAN) node (or device) that connects the UE 310 to a wireless network. The access network device 320 may broadly cover or be replaced with various devices as follows: a node B (NodeB), an evolved NodeB (eNB), a next generation NodeB (gNB), a relay station, an access point, a transmitting and receiving point (TRP), a transmitting point (TP), a master eNB (MeNB), a secondary eNB (SeNB), a multi-standard radio (MSR) node, a home eNB, a network controller, an access node, a wireless node, an access point (AP), a transmitting node, a receiving and transmitting node, a base band unit (BBU), a remote radio unit (RRU), an active antenna unit (AAU), a remote radio head (RRH), a central unit (CU), a distributed unit (DU), a positioning node or the like. The base station is a macro base station, a micro base station, a relay node, a donor node or the like, or a combination thereof. The base station may also refer to a communication module, a modem or a chip disposed in the aforementioned device or apparatus. The base station may also be a mobile switching center, a device that functions as the base station in device-to-device (D2D), vehicle-to-everything (V2X), machine-to-machine (M2M) communications, a network-side device in a 6G network, a device that functions as the base station in a future communication system, or the like. The base station may support networks with the same or different access technologies. The embodiments of the present disclosure do not limit the specific technology and specific device form used by the access network device 320.

The core network device 330 is configured to provide user connection and user management for users of the UE 310 and bear services. For example, the establishment of user connection includes functions such as mobile management (MM) and paging. The user management includes user description, quality of service (QOS), and security (corresponding security measures provided by an authentication center include security management of mobile services and security processing of external network access). Bearer connections include a public switched telephone network (PSTN) to the outside, an external circuit data network, a packet data network, the Internet, and the like.

For example, the core network device 330 may include an access and mobility management function (AMF) network element. The AMF network element is mainly responsible for signaling processing, that is, the AMF network element is mainly responsible for functions of a control plane. The functions of the control plane may include, for example, access control, mobility management, attachment and detachment, and other functions.

For another example, the core network device 330 may also include a session management function (SMF) network element. The SMF network element is mainly responsible for implementing session management functions, such as session establishment, modification, and release.

For another example, the core network device 330 may also include a user plane function (UPF) network element. The UPF network element is mainly responsible for forwarding and receiving user data in the UE 310. For example, the UPF network element may receive the user data from a data network and transmit the user data to the UE 310 by the access network device 320. Alternatively, the UPF network element may also receive the user data from the UE 310 by the access network device 320, and then forward the user data to the data network.

Nodes in the communication system 300 may communicate and/or perform data transmission and reception with each other, thereby forming a communication network. Therefore, the nodes in the communication system may also be referred to as network elements in the communication system or the communication network. The network elements in the communication system are categorized according to physical entities or functions. Where the network elements in the communication system are categorized according to functions, two network elements in the communication system are disposed on the same physical entity or on different physical entities.

The communication system 300 shown in FIG. 3 is any type of communication system with an architecture in which a user plane and a control plane are separated. For example, the communication system 300 is a fifth generation (5G) system or new radio (NR). Alternatively, the communication system 300 may also be applicable to a future communication system, such as a sixth generation mobile communication system or satellite communication system.

The reference sign 340 in FIG. 3 denotes an application server (AS) 340. The AS may or may not be a part of the communication system. Some of the following embodiments are illustrated by taking that the AS is part of the communication system as an example.

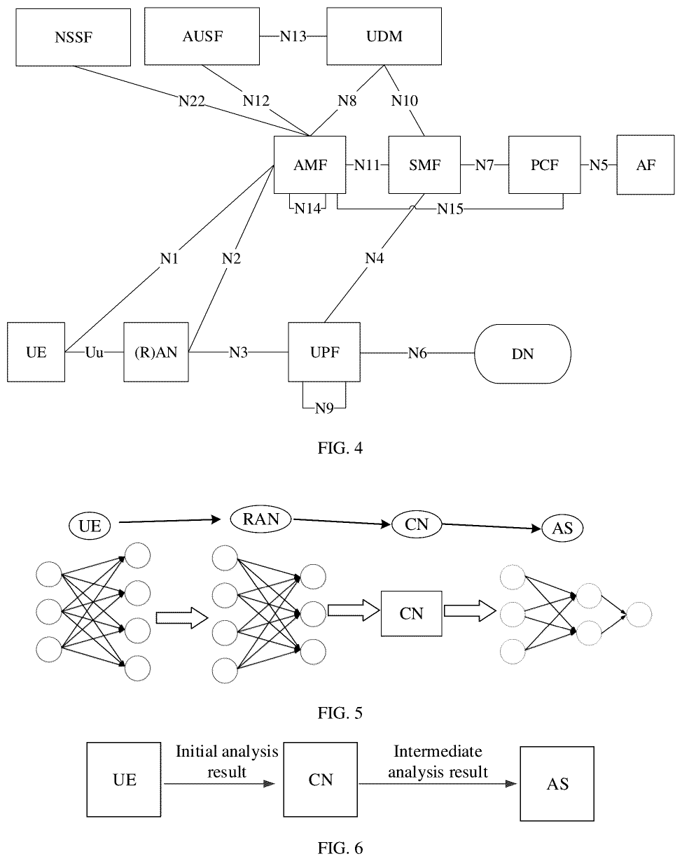

The architecture in which a user plane and a control plane are separated is illustrated in detail hereinafter by taking the 5G communication system as an example in conjunction with FIG. 4.

FIG. 4 is a schematic diagram of 5G system architecture. FIG. 4 shows a network architecture of the 5G communication system. As shown in FIG. 4, the UE performs an access stratum connection to the RAN over a Uu interface, to implement access stratum messages interaction and wireless data transmission.

The UE may establish a non-access stratum (NAS) connection to the AMF over an NI interface to implement NAS messages interaction. In addition to mobility management for the UE, the AMF may also forwards messages related to session management between the UE and the SMF. A policy control function (PCF) is a network element in the core network that is responsible for formulating policies related to mobility management, session management, charging and the like for the UE. The AMF, the SMF and the PCF are all network elements of a control plane in the 5G network architecture. A control plane connection is established between these network elements, and control plane messages are transmitted between these network elements.

The UPF may transmit data with an external data network (DN) over an N6 interface, and transmit data with the RAN over an interface N3. Therefore, the RAN and the UPF belong to the network elements of a user plane in the 5G network architecture. A user plane connection is established between these network elements, and data is transmitted over a pipeline between the UE and the external data network.

In the existing 5G network architecture, control plane signaling is only transmitted between the network elements of the control plane, and user plane data is only transmitted between the network elements of the user plane. In addition, for the user plane data, the network itself does not analyze (or not sense) data content. The network only serves as a pipeline to connect the UE to the external data network. For the control plane connection, the amount of signaling data transmitted by the control plane is usually small. In addition, although the network elements of the control plane may parse the data content, they usually cannot modify the data content. Therefore, for the communication systems with an architecture in which a control plane and a user plane are separated, it is difficult to perform AI-related processing due to constraints of the user plane and the control plane to data transmission requirements.

With the development of the technology, some communication systems (such as the 6G communication system) will introduce AI technology, thereby empowering AI capabilities to all parts of the communication network. For example, various network elements in the communication network may participate in the training and inference process of AI models to perform AI-related processing.

The introduction of AI technology into the communication system may not only require a large amount of AI data to be transmitted between different network elements in the communication system, but may also require the different network elements in the communication system all to parse and modify AI data. For example, in order to train an AI model with a high generalization ability and high precision, the various network elements in the communication system may all be required to provide information needed for training the AI model, or the various network elements in the communication system may all be required to use the AI model to process AI data. Therefore, where only a user plane-based connection and/or a control plane-based connection are/is established between the network elements of the communication system, the communication system may not be able to perform AI-related processing due to data processing modes of the user plane and the control plane mentioned above (for example, not allowing data modification).

For case of understanding, the possible problems of introducing AI technology into the communication system will be illustrated in more detail hereinafter in conjunction with scenarios shown in FIGS. 5 and 6.

AI model segmentation is taken as an example. A neural network (such as a deep neural network) is divided into a plurality of parts by layer, and various parts may be stored in a plurality of network elements of the communication system respectively. When the neural network needs to be trained and/or used for inference, an AI data stream needs to be transferred between the plurality of network elements above in a specific order. FIG. 5 is an example diagram of a scenario in which the communication system is combined with a segmentation model according to some embodiments of the present disclosure. The neural network shown in FIG. 5 adopts a 7-layer structure, including an input layer, five hidden layers and an output layer. The UE may store the input layer and the first hidden layer (i.e., layers L1 and L2) of the neural network; the RAN (specifically, it is an access network device) may store the second hidden layer and the third hidden layer (i.e., layers L3 and L4) of the neural network; the CN (specifically, one or more devices in the core network) may only be responsible for forwarding data of the neural network; and the AS may store the fourth hidden layer, the fifth hidden layer and the output layer of the neural network (i.e. layers L5-L7). When the neural network needs to be trained or used for inference, it is possible to transmit the AI data stream between the UE, the RAN, the CN and AS by taking the UE as a source network element and the AS as a destination network element, and the UE, the RAN and the AS process the AI data stream in sequence. However, where a connection between the plurality of network elements is the user plane connection, the plurality of network elements cannot parse data content of the AI data stream, and thus cannot complete training and/or inference tasks for the neural network; and where a connection between the plurality of network elements is the control plane connection, on the one hand, the control plane connection may not be able to bear the AI data stream with a large amount of data, and on the other hand, although the network elements between which the control plane connection has been established may parse the data content of the AI data stream, they cannot modify the data content of the AI data stream, and thus also cannot complete the training and/or inference tasks for the neural network.

A vertical federated learning scenario is taken as an example. FIG. 6 is an example diagram of a scenario in which the communication system is combined with big data analysis according to some embodiments of the present disclosure. With reference to FIG. 6, network elements such as the UE, the CN, and the AS all store user data of the UE, and different network elements store different types of user data. Due to user privacy issues, the user data cannot be transferred directly between different network elements. Where big data analysis needs to be conducted on a user (such as behaviors, preferences and the like of the user) based on the user data stored in the above three network elements, the vertical federated learning is considered to use. On the premise of ensuring the privacy of user data, their respective analysis results are transmitted between the UE, the CN and the AS. Specifically, first, the UE may use a local model to perform data analysis based on local user data to form an initial analysis result. Upon acquiring the initial analysis result, the UE may transmit (or report) the initial analysis result to the CN. The CN may use a local model to analyze the initial analysis result and locally stored user data to acquire an intermediate analysis result. The CN may then send the intermediate analysis result to the AS. The AS may use a local model to perform data analysis on the intermediate analysis result and locally stored user data to form a final analysis result. In the above application scenario, the various network elements all need to parse and modify the data content in the AI data stream. However, where the connection between the UE and the CN is the user plane connection, the CN cannot parse the data content in the AI data stream, and thus cannot complete the data analysis task; and where the connection between the UE and the CN is the control plane connection, the CN may parse the data content of the AI data stream, but cannot modify the data content, and thus also cannot complete the data analysis task.

In order to enable the communication system to support the transmission of the AI data stream (sometimes also referred to as AI service stream), based on a user plane-based first connection and a control plane-based second connection, the embodiments of the present disclosure introduce a third connection, which is configured to transmit the AI data stream, into the communication system. For facilitating description, the third connection for transmitting the AI data stream will be collectively referred to as “AI connection” in the following text. In some embodiments, the AI connection is dedicated to processing and/or transmitting the AI data stream.

The AI data stream is transmitted on a transmission path (or forwarding path) of the AI data stream. Two or more network elements of the communication system are involved on the transmission path of the AI data stream. The two or more network elements are any network elements in the communication system.

For example, the transmission path of the AI data stream may start from any one of the UE, the RAN, the CN, and the AS; and/or the transmission path of the AI data stream may terminate at any one of the UE, the RAN, the CN, and the AS.

For another example, the transmission path of the AI data stream may exist only in uplink, only in downlink, or in both the uplink and the downlink.

The AI connection is established in advance between the network elements on the transmission path of the AI data stream. In addition, the control plane connection and/or the user plane connection may also be established between the network elements on the transmission path of the AI data stream. In other words, the AI connection is established on the basis of the network elements between which the control plane connection and/or user plane connection have/has been established, such that the AI data stream is freely routed between the network elements of the control plane and/or the user plane of the communication system without being constrained by the control plane connection and/or the user plane connection. For example, the AI connection is established between two or more network elements between which the control plane connection has been established, and a large number of AI data streams are transmitted between the two or more network elements without being limited by the control plane on the amount of signaling transmission data. For another example, the AI connection is established between two or more network elements between which the user plane connection has been established and the two or more network elements may parse and modify the AI data stream without being limited by the fact that the network elements of the user plane do not parse the data content and only perform pipeline transmission.

In some embodiments, the AI connection may support parsing and/or modification of content of a data portion (i.e., payload) in the AI data stream by the network elements on the transmission path. It should be understood that although the AI connection supports parsing and/or modification of the content of the data portion in the AI data stream by the network elements on the transmission path, this does not mean that the network elements on the transmission path must parse and/or modify the content of the data portion in the AI data stream. For example, in some embodiments, the network elements on the transmission path may all be required to parse and/or modify the content of the data portion in the AI data stream. For another example, in some other embodiments, a part of network elements on the transmission path may be required to parse and modify the content of the data portion in the AI data stream, while the other part of network elements may be required not to parse and modify the content of the data portion in the AI data stream, but only forward the AI data stream. During an actual transmission process, whether a specific network element on the transmission path parses and/or modifies the content of the data portion in the AI data stream is determined according to one or more of: a service type of the AI data stream, the processing capability of the network element, and the type of a local model of the network element, and the like.

As mentioned above, the network elements between which the user plane connection is established usually do not parse the data content transmitted thereon, and the network elements between which the control plane connection is established usually do not modify the data transmitted thereon. In the embodiments of the present disclosure, a new connection for transmitting the AI data stream is introduced on the basis of the user plane-based connection and the control plane-based connection to support AI-related processing on the communication system. Compared with the user plane connection and the control plane connection, the AI connection proposed in the embodiments of the present discourse supports parsing and modification of the content of the data portion in the AI data stream by the network elements, such that the communication system may better support AI-related processing. Moreover, the design of the AI connection enables the network elements in the communication system to determine whether the various network elements parse and/or modify the AI data stream according to actual conditions, thereby improving the flexibility of AI data stream transmission.

The AI data stream may bear any type of AI-related data. The above data may be data used or generated in a training phase of an AI model, or data used or generated by the AI model in an inference phase (or referred to as an actual use phase).

For example, the AI data stream may include at least one of: input data of the AI model, model parameters of the AI model, a final result output by the AI model, an intermediate result output by the AI model, or a configuration parameter of the AI model.

The input data of the AI model may, for example, include a training sample in the training phase and/or task data to be processed in the inference phase. The model parameters of the AI model may, for example, include temporary model parameters which are generated in the training phase and need to be updated, or may include model parameters of the trained AI model. The final result of the AI model may, for example, include data (such as a prediction result) output by an output layer of the AI model. The intermediate result of the AI model may, for example, include a temporary result output by neurons of an input layer and/or hidden layer or a neural network layer of the AI model. The configuration parameters of the AI model are, for example, hyperparameters of the AI model, the number of channels of the AI model, the size of a convolution kernel of the AI model, or the like.

On the basis of introducing the AI connection, various forms of routing modes are established based on the AI connection. Two possible routing modes based on the AI connection are introduced hereinafter.

The AI connection is set such that the AI data stream is routed based on behaviors. By taking the scenario shown in FIG. 5 as an example, the UE stores the input layer and the first hidden layer (i.e., layers L1 and L2) of the neural network; the RAN stores the second hidden layer and the third hidden layer (i.e., layers L3 and L4) of the neural network; and the AS stores the fourth hidden layer, the fifth hidden layer and the output layer (i.e., layers L5-L7) of the neural network. In this case, where the AI data stream needs to be processed using the neural network, an AI connection between the UE, the RAN, the CN, and the AS is established, such that the AI data stream is routed according to the following transmission path: UE→RAN→CN→AS. In addition, since different network elements store different parts of the neural network, the operating behaviors of various nodes may also be configured as follows: the UE uses the input layer and the first hidden layer to process the AI data stream; the RAN uses the second hidden layer and the third hidden layer to process the AI data stream processed by the UE; the CN does not process the AI data stream processed by the RAN, but only forwards the AI data stream; and the AS uses the fourth hidden layer, the fifth hidden layer and the output layer to process the AI data stream processed by the RAN. It can be seen from the above routing mode of the AI data stream that the operating behaviors of the different network elements may not exactly the same. In other words, the above routing mode is a behavior-based routing mode, and the AI connection according to the embodiments of the present disclosure may support such a routing mode.

The AI connection is set such that the AI data stream is routed based on content. By taking the scenario shown in FIG. 6 as an example, in order to implement big data analysis based on vertical federated learning between the UE, the CN, and the AS, the AI connection is established between the UE, the CN, and the AS in advance. In an actual data analysis process, the UE first uses a local model to perform data analysis on local user data to form an initial analysis result. Upon acquiring the initial analysis result, the UE transmits (or reports) the initial analysis result to the CN over the AI connection between the UE and the CN. The CN may use a local model to perform secondary analysis on the initial analysis result and locally stored user data to acquire an intermediate analysis result. The CN then sends the intermediate analysis result to the AS over the AI connection between the CN and the AS. The AS may use a local model to analyze the intermediate analysis result and locally stored user data again to form a final analysis result. In this way, user-specific big data analysis is completed based on the user data of the various network elements on the premise of ensuring user privacy. In the above routing mode, the various network elements all need to parse and modify the data content in the AI data stream, such that the processing results of the user data are shared between the plurality of network elements. In the embodiments of the present disclosure, this routing mode is referred to as a content-based routing mode, and the AI connection according to the embodiments of the present disclosure may support such a routing mode.

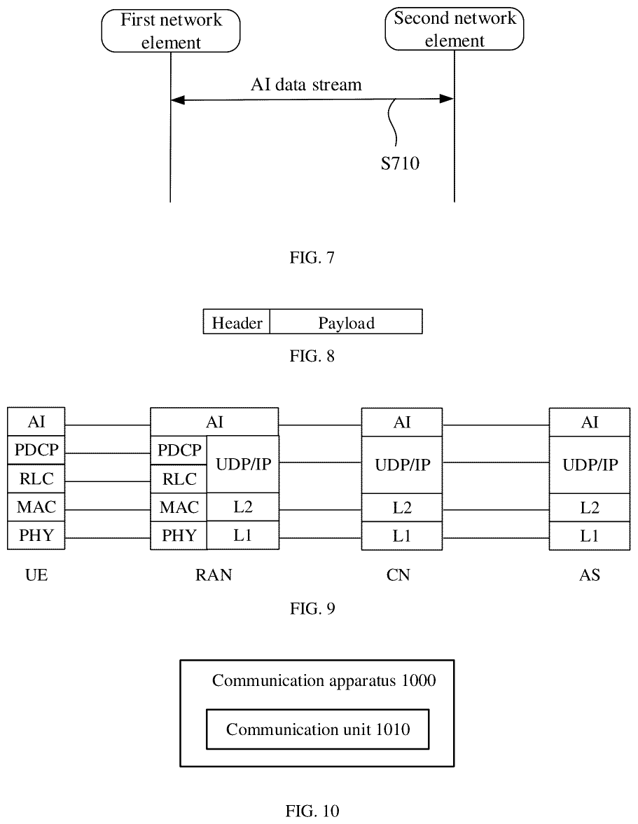

The embodiments of the present disclosure are illustrated hereinafter in conjunction with FIG. 7 by taking interaction between the first network element and the second network element on the transmission path of the AI data stream as an example. It should be understood that the first network element and the second network element are any two network elements on the transmission path of the AI data stream.

FIG. 7 is a schematic flowchart of a method applicable to the communication system according to some embodiments of the present disclosure. As shown in FIG. 7, in step S710, a first network element sends to or receives from a second network element an AI data stream over an AI connection. The first network element and the second network element are any two network elements in the communication system. For example, the first network element is the UE, and the second network element is the access network device. For another example, the first network element is the access network device, and the second network element is the core network device. For still another example, the first network element and the second network element are both core network devices or two nodes within a core network. For yet still another example, the first network element is the core network device, and the second network element is the AS. A link between the first network element and the second network element is an uplink or a downlink. In addition to the AI connection, a user plane connection and/or a control plane connection may also be established between the first network element and the second network element. The AI data stream may start from one of the first network element and the second network element, and terminate at the other of the first network element and the second network element. Alternatively, the first network element and the second network element may also be part of the network elements that are involved on the transmission path of the AI data stream.

During transmission, the AI data stream is usually transmitted in the form of a data packet. A design mode of the data packet of the AI data stream is illustrated in detail hereinafter in conjunction with FIG. 8.

FIG. 8 is a structural schematic diagram of a header of a data packet in an AI data stream according to some embodiments of the present disclosure. FIG. 8 shows a possible design form of the data packet in the AI data stream. It can be seen from FIG. 8 that the data packet may include a header and a payload. Parameters in the header are designed according to the characteristics of the AI data stream and/or the type of an AI service. For example, the header of the data packet of the AI data stream may include one or more of first to sixth parameters described hereinafter.

The first parameter may indicate or identify a source network element (or an initiator) of the AI data stream. A field including the first parameter is referred to as “source”. The first parameter is, for example, an address (or referred to as an address identifier) of the source network element. The address of the source network element is designed in a form similar to an IP address or in the form of a domain name.

The second parameter may indicate or identify a destination network element (or a final receiver) of the AI data stream. A field including the second parameter is referred to as “to”. The second parameter is, for example, an address (or referred to as an address identifier) of the destination network element. The address of the destination network element is designed in a form similar to an IP address or in the form of a domain name.

The third parameter may indicate or identify a network element that the AI data stream needs to travel through on the transmission path of the AI data stream. A field including the third parameter is referred to as “via”. The third parameter is, for example, an address (or referred to as an address identifier) of the network element that the AI data stream needs to travel through on the transmission path of the AI data stream. The address of the network element that the AI data stream needs to travel through on the transmission path of the AI data stream is designed in a form similar to an IP address or in the form of a domain name.

The fourth parameter may indicate or identify an operation behavior of the network element on the transmission path of the AI data stream for the data portion (payload) in the AI data stream. A field including fourth parameter is referred to as “operation identifier”.

The operation behavior is defined in many ways. As an example, the operation behavior may include the following two behaviors: 1. processing the AI data stream, that is, parsing and/or modifying the data content in the AI data stream; and 2. not processing the AI data stream but only forwarding the AI data stream. Where the operation behavior of a specific network element is configured as the first behavior, upon receiving the AI data stream, the network element may first use the local model to parse and/or modify data in the AI data stream, and then forward the processed AI data stream to the next network element. Where the operation behavior of a specific network element is configured as the second behavior, upon receiving the AI data stream, the network element may directly forward the AI data stream to the next network element.

As another example, the operation behavior may not only include whether to process the AI data stream, but may also include how to process the AI data stream. By taking the scenario shown in FIG. 5 as an example, the fourth parameter may not only indicate whether the various network elements on the transmission path process the AI data stream, but also indicate, to the network element that needs to process the AI data stream, which layer of the neural network that the network element is based on for processing the AI data stream.

The fifth parameter may indicate an encryption key of the data portion (payload) in the AI data stream. For example, the fifth parameter is an encryption key identifier of the data portion in the AI data stream. A field including the fifth parameter is referred to as “key identifier”. Based on the fifth parameter, the network elements on the transmission path may encrypt or decrypt the data in the AI data stream.

The sixth parameter may indicate or identify a network element that the AI data stream has traveled through. A field including the sixth parameter is referred to as “record”. The sixth parameter is, for example, an address (or an address identifier) of the network element that the AI data stream has traveled through. The address of the network element that the AI data stream has traveled through is designed in a form similar to an IP address or in the form of a domain name. In an actual transmission process, each time the AI data stream travels through one network element on the transmission path, the value of the sixth parameter is updated to record the address of the network element in the sixth parameter.

Table 1 gives a specific example of parameters of the header. The parameters of the header are designed in a way that it may well support the transmission of the AI data stream in the scenario shown in FIG. 5.

TABLE 1
Header of data packet in AI data stream

| | |
|---|---|
| Source | address of UE |
| To | address of AS |
| Via | address of RAN and address of CN |
| Operation | address of UE: input layer and first hidden layer, i.e., L1 and |
| ID | L2 |
| | address of RAN: second hidden layer and third hidden layer, |
| | i.e., L3 and L4 |
| | address of CN: forward |
| | address of AS: fourth hidden layer, fifth hidden layer and |
| | output layer, i.e., L5-L7 |
| Key ID | KEY 1 |
| Record | address of UE, address of RAN, . . . |

It can be seen from FIG. 1 that for the AI data stream, the source network element is the UE, the destination network element is the AS, and the AI data stream travels through the RAN and the CN. In an AI data stream transmission process, the UE needs to use the locally stored input layer and first hidden layer (i.e., layers L1 and L2) of the neural network to process the data in the AI data stream. Upon receiving the AI data stream sent by the UE, the RAN needs to use the locally stored second hidden layer and third hidden layer (i.e., layers L3 and L4) of the neural network to process the data in the AI data stream. Upon receiving the AI data stream sent by the RAN, the CN does not need to process the data in the AI data stream, and directly forward the AI data stream. Upon receiving the AI data stream sent by the CN, the AS needs to use the locally stored fourth hidden layer, fifth hidden layer and output layer (i.e., L5-L7) of the neural network to process the data in the AI data stream. Prior to processing the data in the AI data stream, the UE, the RAN and the AS may first use KEY 1 to decrypt the data portion in the AI data stream.

Parameters in the header of the data packet which are related to the source network element, the destination network element, and the network elements that the AI data stream needs to travel through on the transmission path may be freely set according to actual needs, thereby realizing free routing of the AI data stream in the communication system. Furthermore, parameters related to the operation behavior of the network element are introduced into the header of the data packet, such that the AI data stream may be routed in the communication network based on the operation behavior of the network element.

In order to support the AI connection, the third generation partnership project (3GPP) protocol stack may be updated and a new protocol layer corresponding to the AI connection (or a protocol layer supporting the AI connection) is added. The header of the data packet in the AI data stream mentioned above may be added by this new protocol layer.

The protocol layer corresponding to the AI connection may be referred to as an AI layer. As a possible implementation, this AI layer may be on the top layer of the 3GPP protocol stack.

FIG. 9 is an example diagram of a structure of a protocol stack capable of supporting an AI connection according to some embodiments of the present disclosure. By taking the UE as an example, with reference to FIG. 9, in an existing protocol, a protocol stack of the UE includes a physical (PHY) layer, a media access control (MAC) layer, a radio link control (RLC) layer, and a Packet Data Convergence Protocol (PDCP) layer in sequence. For the UE, the protocol layer corresponding to the AI connection may be above the PDCP layer of the protocol stack of the UE.

By taking the RAN as an example, with reference to FIG. 9, in the existing protocol, in protocol stacks of the RAN, a protocol stack that interfaces with the UE may include a PHY layer, an MAC layer, an RLC layer and a PDCP layer from bottom to top in sequence, and a protocol stack that interfaces with the core network device includes a layer L1, a layer L2, and a User Datagram Protocol (UDP)/Internet Protocol (IP) layer from bottom to top in sequence. For the RAN, the protocol layers corresponding to the AI connections may be above the PDCP layer and the UDP/IP layer of the protocol stacks of the access network device.

By taking the CN or the AS as an example, with reference to FIG. 9, in the existing protocol, a protocol stack of the CN or the AS includes a layer L1, a layer L2 and a UDP/IP layer from bottom to top in sequence. For the CN and the AS, the protocol layer corresponding to the AI connection may be above the PDCP layer of the protocol stack of the CN or the AS.

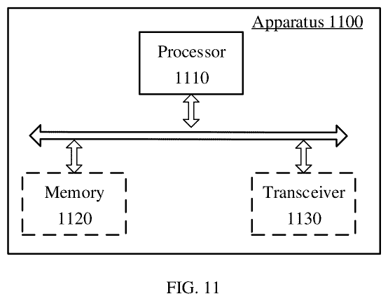

The method embodiments of the present disclosure are described in detail above in conjunction with FIG. 1 to FIG. 9, and device embodiments of the present disclosure are described in detail hereinafter in conjunction with FIG. 10 and FIG. 11. It should be understood that the description of the method embodiments corresponds to the description of the device embodiments. Therefore, for the parts that are not described in detail, reference may be made to the previous method embodiments.

FIG. 10 is a structural schematic diagram of a communication apparatus according to some embodiments of the present disclosure. As shown in FIG. 10, the communication apparatus 1000 is disposed in a communication system. The communication system supports establishments of a user plane-based first connection, a control plane-based second connection, and a third connection for transmitting an AI data stream for a network element in the communication system, wherein a plurality of network elements of the communication system are involved on a transmission path of the AI data stream, and the third connection is established between the plurality of network elements, and the plurality of network elements includes a first network element and a second network element, and the communication apparatus is the first network element.

The communication apparatus 1000 includes a communication unit 1010. The communication unit 1010 is configured to send to or receive from the second network element the AI data stream over the third connection.

In some embodiments, a data packet of the AI data stream includes a header portion and a data portion. The header portion includes one or more of: a first parameter indicative of a source network element of the AI data stream; a second parameter indicative of a destination network element of the AI data stream; a third parameter indicative of a network element that the AI data stream needs to travel through on the transmission path; a fourth parameter indicative of an operation behavior of the network element on the transmission path for the AI data stream; a fifth parameter indicative of an encryption key of the data portion in the AI data stream; or a sixth parameter indicative of a network element that the AI data stream has traveled through on the transmission path.

In some embodiments, the first parameter is an address of the source network element; or the second parameter is an address of the destination network element; or the third parameter is an address of the network element that the AI data stream needs to travel through on the transmission path; or the sixth parameter is an address of the network element that the AI data stream has traveled through.

In some embodiments, a 3GPP protocol stack of the network element on the transmission path includes a protocol layer corresponding to the third connection.

In some embodiments, the protocol layer corresponding to the third connection is on the top layer of the 3GPP protocol stack.

In some embodiments, the communication apparatus is a user equipment, and the protocol layer corresponding to the third connection is above a PDCP layer of a protocol stack of the user equipment; or the communication apparatus is an access network device, and the protocol layers corresponding to the third connections are above a PDCP layer and a UDP/IP layer of protocol stacks of the access network device; or the communication apparatus is a core network device, and the protocol layer corresponding to the third connection is above a UDP/IP layer of a protocol stack of the core network device; or the communication apparatus is an application server, and the protocol layer corresponding to the third connection is above a UDP/IP layer of a protocol stack of the application server.

In some embodiments, the third connection supports parsing and modification of content of a data portion in the AI data stream by the network elements on the transmission path.

In some embodiments, the network elements on the transmission path include network elements between which a control plane connection is established and/or network elements between which a user plane connection is established.

In some embodiments, the AI data stream includes at least one of: input data of an AI model; model parameters of the AI model; a final result output by the AI model; an intermediate result output by the AI model; or configuration parameters of the AI model.

FIG. 11 is a structural schematic diagram of an online trained apparatus according to some embodiments of the present disclosure. Dashed lines in FIG. 11 indicate that units or modules are alternative. The apparatus 1100 may be configured to implement the method described in the above method embodiment. The apparatus 1100 may be a chip or a network element (such as the first network element mentioned above).

The apparatus 1100 may include one or more processors 1110. The processor 1110 may support the apparatus 1100 in implementing the method described in the above method embodiment. The processor 1110 may be a general-purpose processor or a special-purpose processor. For example, the processor may be a central processing unit (GPU). Alternatively, the processor may also be another general-purpose processor, a digital signal processor (DSP), an application specific integrated circuit (ASIC), a field programmable gate array (FPGA), or other programmable logic device, a discrete gate or transistor logic device, a discrete hardware component or the like. The general-purpose processor may be a microprocessor or the processor may be any conventional processor.

The apparatus 1100 may further include one or more memories 1120. The memory 1120 stores a program, which may be executed by the processor 1110, such that the processor 1110 performs the method described in the above method embodiment. The memory 1120 may be independent of the processor 1110 or integrated in the processor 1110.

The apparatus 1100 may further include a transceiver 1130. The processor 1110 may communicate with other devices or chips by the transceiver 1130. For example, the processor 1110 may transmit data to or receive data from other devices or chips by the transceiver 1130.

Embodiments of the present disclosure further provide a non-transitory computer-readable storage medium configured to store a program. The computer-readable storage medium is applicable to the first network element according to the embodiments of the present disclosure, and the program causes a computer to perform the method performed by the first network element according to various embodiments of the present disclosure.

Embodiments of the present disclosure further provide a computer program product. The computer program product includes a program. The computer program product is applicable to the first network element according to the embodiments of the present disclosure, and the program causes a computer to perform the method performed by the first network element according to various embodiments of the present disclosure.

Embodiments of the present disclosure further provide a computer program. The computer program is applicable to the first network element according to the embodiments of the present disclosure, and the computer program causes a computer to perform the method performed by the first network element according to various embodiments of the present disclosure.

It should be understood that in the embodiments of the present disclosure, “B corresponding to A” means that B is associated with A, and B may be determined according to A. But it should also be understood that determining B according to A does not mean determining B only according to A, but means that B may also be determined according to A and/or other information.

It should be understood that the term “and/or” in this specification describes only an association relationship for describing associated objects, and represents that three relationships may exist. For example, A and/or B may represent the following three cases: only A exists, both A and B exist, and only B exists. In addition, the character “/” in this specification generally indicates an “or” relationship between the associated objects.

It should be understood that according to various embodiments of the present disclosure, the size of the serial numbers of the above processes does not mean the execution order. The execution order of the various processes should be determined according to their functions and internal logic, and should not constitute any limitation to the implementation process of the embodiment of the present disclosure.

In the embodiments of the present disclosure, it should be understood that the disclosed systems, apparatuses and methods may be implemented in other ways. For example, the apparatuses embodiments described above are merely schematic. For example, the division of units are only division based on logical functions. There may be other division modes during actual implementation. For example, a plurality of units or components may be combined or integrated into another system, or some features may be ignored or not executed. In addition, mutual coupling or direct coupling or communication connection as shown or discussed may be indirect coupling or communication connection by some interfaces, apparatuses or units, and may be in electrical, mechanical or other forms.

The units described as separated components are or not are physically separated. The components displayed as units are or not are physical units, that is, they are disposed in one place or are distributed on a plurality of network units. Part or all of the units are selected according to actual needs to achieve the purposes of the solutions of the embodiments.

In addition, all functional units in the embodiments of the present disclosure may be integrated into one processing unit; or each unit exists physically independently; or two or more units may be integrated into one unit.

The above embodiments may be fully or partially implemented by software, hardware, firmware, or any combination thereof. When implemented by software, the embodiments may be fully or partially implemented in the form of a computer program product. The computer program product includes one or more computer instructions. When the computer program instructions are loaded and executed on a computer, the flows or functions according to the embodiments of the present disclosure are fully or partially generated. The computer is a general-purpose computer, a special-purpose computer, a computer network, or other programmable apparatuses. The computer instructions are stored in a computer-readable storage medium or transmitted from one computer-readable storage medium to another computer-readable storage medium. For example, the computer instructions are transmitted from one website, computer, server, or data center to another website, computer, server or data center in a wired (such as a coaxial cable, an optical fiber and a digital subscriber line, DSL), or wireless (such as infrared, wireless and microwave) fashion. The computer-readable storage medium is any available medium accessible by a computer or a data storage device integrated with one or more available mediums, such as a server or a data center. The available medium is a magnetic medium (such as a floppy disk, a hard disk, and a magnetic tape), an optical medium (for example, a digital video disc, DVD), or a semiconductor medium (for example, a solid-state disk, SSD), or the like.

Described above are exemplary embodiments of the present disclosure, but the protection scope of the present disclosure is not limited to these exemplary embodiments. Various variations or substitutions readily conceivable by those skilled in the art within the technical scope disclosed in the present disclosure should fall within the protection scope of the present disclosure. Therefore, the protection scope of the present disclosure should be subjected to the appended claims.

1. A method applicable to a communication system, wherein
the communication system supports establishments of a user plane-based first connection, a control plane-based second connection, and a third connection for transmitting an artificial intelligence (AI) data stream for a network element in the communication system, wherein a plurality of network elements of the communication system are involved on a transmission path of the AI data stream, the third connection is established between the plurality of network elements, and the plurality of network elements comprise a first network element and a second network element; and
the method comprises:
sending to or receiving from the second network element, by the first network element, the AI data stream over the third connection.

2. The method according to claim 1, wherein a data packet of the AI data stream comprises a header portion and a data portion, wherein the header portion comprises one or more of:
a first parameter indicative of a source network element of the AI data stream;
a second parameter indicative of a destination network element of the AI data stream;
a third parameter indicative of a network element that the AI data stream needs to travel through on the transmission path;
a fourth parameter indicative of an operation behavior of the network element on the transmission path for the AI data stream;
a fifth parameter indicative of an encryption key of the data portion in the AI data stream; or
a sixth parameter indicative of a network element that the AI data stream has traveled through on the transmission path.

3. The method according to claim 2, wherein there is at least one of:
the first parameter is an address of the source network element;
the second parameter is an address of the destination network element;
the third parameter is an address of the network element that the AI data stream needs to travel through on the transmission path; or
the sixth parameter is an address of the network element that the AI data stream has traveled through.

4. The method according to claim 1, wherein a third generation partnership project (3GPP) protocol stack of the network element on the transmission path comprises a protocol layer corresponding to the third connection.

5. The method according to claim 4, wherein the protocol layer corresponding to the third connection is on a top layer of the 3GPP protocol stack.

6. The method according to claim 4, wherein there is at least one of:
the network element on the transmission path comprises a user equipment, and the protocol layer corresponding to the third connection is above a Packet Data Convergence Protocol (PDCP) layer of a protocol stack of the user equipment;
the network element on the transmission path comprises an access network device, and the protocol layer corresponding to the third connection is above a PDCP layer and a User Datagram Protocol (UDP)/Internet Protocol (IP) layer of a protocol stack of the access network device;
the network element on the transmission path comprises a core network device, and the protocol layer corresponding to the third connection is above a UDP/IP layer of a protocol stack of the core network device; or
the network element on the transmission path comprises an application server, and the protocol layer corresponding to the third connection is above a UDP/IP layer of a protocol stack of the application server.

7. The method according to claim 1, wherein the third connection supports parsing and modification of content of a data portion in the AI data stream by the network element on the transmission path.

8. The method according to claim 1, wherein the network elements on the transmission path comprise network elements between which a control plane connection is established and/or network elements between which a user plane connection is established.

9. The method according to claim 1, wherein the AI data stream comprises at least one of:
input data of an AI model;
model parameters of the AI model;
a final result output by the AI model;
an intermediate result output by the AI model; or
configuration parameters of the AI model.

10. A communication apparatus, wherein
the communication apparatus is disposed in a communication system, the communication system supports establishments of a user plane-based first connection, a control plane-based second connection, and a third connection for transmitting an artificial intelligence (AI) data stream for a network element in the communication system, wherein a plurality of network elements of the communication system are involved on a transmission path of the AI data stream, the third connection is established between the plurality of network elements, the plurality of network elements comprises a first network element and a second network element, and the communication apparatus is the first network element; and
the communication apparatus comprises a memory and a processor, wherein the memory is configured to store a program, and the processor is configured to call the program from the memory to perform:
sending to or receiving from the second network element, by the first network element, the AI data stream over the third connection.

11. The communication apparatus according to claim 10, wherein a data packet of the AI data stream comprises a header portion and a data portion, wherein the header portion comprises one or more of:
a first parameter indicative of a source network element of the AI data stream;
a second parameter indicative of a destination network element of the AI data stream;
a third parameter indicative of a network element that the AI data stream needs to travel through on the transmission path;
a fourth parameter indicative of an operation behavior of the network element on the transmission path for the AI data stream;
a fifth parameter indicative of an encryption key of the data portion in the AI data stream; or
a sixth parameter indicative of a network element that the AI data stream has traveled through on the transmission path.

12. The communication apparatus according to claim 11, wherein there is at least one of:
the first parameter is an address of the source network element;
the second parameter is an address of the destination network element;
the third parameter is an address of the network element that the AI data stream needs to travel through on the transmission path; or
the sixth parameter is an address of the network element that the AI data stream has traveled through.

13. The communication apparatus according to claim 10, wherein a third generation partnership project (3GPP) protocol stack of the network element on the transmission path comprises a protocol layer corresponding to the third connection.

14. The communication apparatus according to claim 13, wherein the protocol layer corresponding to the third connection is on a top layer of the 3GPP protocol stack.

15. The communication apparatus according to claim 13, wherein there is at least one of:
the communication apparatus is a user equipment, and the protocol layer corresponding to the third connection is above a Packet Data Convergence Protocol (PDCP) layer of a protocol stack of the user equipment;
the communication apparatus is an access network device, and the protocol layer corresponding to the third connection is above a PDCP layer and a User Datagram Protocol (UDP)/Internet Protocol (IP) layer of a protocol stack of the access network device;
the communication apparatus is a core network device, and the protocol layer corresponding to the third connection is above a UDP/IP layer of a protocol stack of the core network device; or
the communication apparatus is an application server, and the protocol layer corresponding to the third connection is above a UDP/IP layer of a protocol stack of the application server.

16. The communication apparatus according to claim 10, wherein the third connection supports parsing and modification of content of a data portion in the AI data stream by the network element on the transmission path.

17. The communication apparatus according to claim 10, wherein the network elements on the transmission path comprise network elements between which a control plane connection is established and/or network elements between which a user plane connection is established.

18. The communication apparatus according to claim 10, wherein the AI data stream comprises at least one of:
input data of an AI model;
model parameters of the AI model;
a final result output by the AI model;
an intermediate result output by the AI model; or
configuration parameters of the AI model.

19. (canceled)

20. The method according to claim 7, wherein
the third connection supports parsing and modification of content of a data portion in the AI data stream by all the network elements on the transmission path; or
the third connection supports parsing and modification of content of a data portion in the AI data stream by a part of the network elements on the transmission path.

21. A chip, comprising: a processor configured to call a program from a memory to cause a device provided with the chip to perform a method applicable to a communication system, wherein
the communication system supports establishments of a user plane-based first connection, a control plane-based second connection, and a third connection for transmitting an artificial intelligence (AI) data stream for a network element in the communication system, wherein a plurality of network elements of the communication system are involved on a transmission path of the AI data stream, the third connection is established between the plurality of network elements, and the plurality of network elements comprise a first network element and a second network element; and
the method comprises:
sending to or receiving from the second network element, by the first network element, the AI data stream over the third connection.
